(19) United States
(12) Patent Application Publication
(10) Pub. No.: US 2009/0287346 A1
(43) Pub. Date: Nov. 19, 2009

(54) Drive for the Cross Belt of a Cross Belt Sorter

(76) Inventors: Dieter Hirsch, Erlangen (DE); Martin Linke, Munchen (DE); Alois Lorenz, Griesbach (DE); Torsten Tanz, Hilzingen (DE)

Correspondence Address: SIEMENS CORPORATION;INTELLECTUAL PROPERTY DEPARTMENT, 170 WOOD AVENUE SOUTH, ISELIN, NJ, 08830, US

(21) Appl. No.: 12/466,641

(22) Filed: May 15, 2009

(30) Foreign Application Priority Data
May 15, 2008 (DE) 10 2008 023 685.3

(51) Int. Cl. B65G 49/00; G06F 19/00

(52) U.S. Cl. 700/230; 414/222.13

(57) ABSTRACT

A cross belt sorter is provided for transporting and sorting piece goods, composed of a plurality of sorter elements which are moved on a conveyor track and which are coupled to form a train or can be moved individually and which are in each case provided with a cross belt which circulates continuously around deflection rollers and can be driven transversely with respect to the transport direction of the sorter elements and on which the piece goods can be transported in a resting position and loaded and/or unloaded at fixed loading and/or unloading locations, for which purpose at least one deflection roller of the cross belt corresponds to a drive. The drive of the at least one deflection roller for the cross belt be provided by means of a barrel motor which is arranged within the deflection roller.

### CROSS REFERENCE TO RELATED APPLICATIONS

This application claims priority of German application No. 10 2008 023 685.3 DE filed May 15, 2008, which is incorporated by reference herein in its entirety.

### FIELD OF INVENTION

The invention relates to a cross belt sorter for transporting and sorting piece goods, composed of a plurality of sorter elements which are moved on a conveyor track and which are coupled to form a train or which can be moved individually and which are in each case provided with a cross belt which circulates continuously around deflection rollers and can be driven transversely with respect to the transport direction of the sorter elements and on which the piece goods can be transported in a resting position and loaded and/or unloaded at fixed loading and/or unloading locations, for which purpose at least one deflection roller of the cross belt corresponds to a drive.

### BACKGROUND OF INVENTION

Cross belt sorters of said type are part of a heavy duty sorting system for sorting piece goods, which sorting system is generally composed of a horizontally or vertically encircling sequence of sorter elements which carry the piece goods to be sorted to their intended location (sorting destination), where the sorter elements are mechanically or electrically activated.

The piece goods, as they are being transported, rest on the endless cross belt which is arranged on the sorter element, which cross belt is guided by two deflection rollers which are spaced apart from one another and whose axles are aligned in the transport direction of the sorter elements. At least one of the deflection rollers can be activated by means of a drive such that the encircling cross belt discharges the piece goods, which are resting thereon, transversely with respect to the transport direction. Said type of sorters are referred to as cross band, cross belt or also crossbelt sorters and are known in many variations on the market.

The drive of the cross belts of said sorters continues to cause reliability and/or cost problems; furthermore, the previously-used designs require a large amount of installation space.

Two basic solutions are known for the drive of the cross belts of the sorter elements. In the first solution, the drive of the cross belts is realized by means of an electric motor with a belt pulley on a toothed belt, which in turn drives a belt pulley on the driven deflection roller of the cross belt. Said solution has the disadvantages of the high level of mechanical wear, the susceptibility to dirt accumulation, and a large installation space since the belt pulleys and the dimensions of the drive belts may not undershoot certain values on account of the power to be transmitted and the material properties of the belt. Additional electronic control units with electronic line connections, which are susceptible to failure, are also required.

The second solution which has been realized is composed of a mechanical friction wheel drive of the cross belt. The energy for driving the friction wheel—bevel gear transmission—friction wheel combination is obtained from the relative movement of the sorter elements with respect to a stationary substructure by means of the articulated connection of an actuating flap to the first friction wheel (drive wheel). Significant disadvantages of the second solution are likewise the mechanical wear, the susceptibility to dirt accumulation, and the large installation space, since the friction wheels and the bevel gear transmission also may not deviate from certain dimensions on account of the power to be transmitted. A further disadvantage is that it is not possible to actively influence the speed and acceleration values of the cross belt.

### SUMMARY OF INVENTION

It is the object of the present invention to create a cost-effective, reliable and space-saving drive for the cross belt of generic sorter elements.

To achieve the object, it is proposed that drive of the at least one deflection roller for the cross belt be provided by means of a barrel motor which is arranged within the at least one deflection roller.

Barrel motors are known per se, and serve inter alia to drive conveyor belts for transporting an extremely wide variety of bulk goods. As a result of the compact, space-saving design and the reduction to a small number of components, the barrel motor has increasingly forced the standard geared motor out of the field of conveyor technology. The barrel motor is conventionally composed of an electric motor, a gearing, two flanges with receptacles for the bearing arrangement and a tube in which all the components are accommodated.

In the application according to the invention of barrel motors for driving the cross belts of generic sorter elements, cost and reliability advantages and also a significant reduction in required installation space can be expected. Cost advantages are obtained in particular as a result of the omission of the external drive and its power transmission to the drive roller. Reliability advantages are obtained as a result of the elimination of a plurality of external power transmission elements, which were hitherto exposed to external influences such as dust and foreign bodies. Also, the lubricant required for the functioning of the drive cannot inadvertently escape into the environment.

In one particularly expedient refinement of the invention, it is proposed that the control electronics for the cross belt of the sorter element are arranged together with the barrel motor within the at least one deflection roller. As a result of said refinement, the entire drive is extremely compact and functional, it is very simple to exchange defective or worn deflection rollers, and the spatial requirement of the drive is negligible.

If, according to the invention, the devices for data communication are also arranged within the drive roller, an installation space is required which is no larger than that required for the simple deflection roller. All the components and control elements required for controlling and operating the sorter element or the cross belt are nevertheless combined.

The means and measures of the invention make it possible for the speed and acceleration of the transverse belt to be varied externally by means of data communication (for example CanOpen bus) by means of the control electronics, and corresponding actuators, integrated in the deflection roller.

According to the invention, all the required digital signals (input/output) or sensor signals can be detected directly by means of the control electronics and can be sampled, and if appropriate manipulated, externally via a bus.

A particular advantage of the use according to the invention of the barrel motors in mobile sorter elements is that barrel motors of low-voltage variants of less than 48V are installed into the drive roller. In this way, the energy transmission from the stationary part of the sorter to the mobile part, the sorter elements, can be made considerably simpler and more cost-effective.

The drive energy for the barrel motors may for example be transmitted to the sorter element via contact lines or inductively, or derived from energy stores which are carried on the sorter elements.

The invention has several advantages, since at least one of the two deflection rollers of the cross belt is replaced by a roller with an integrated electric motor and the control electronics. The external control electronics are eliminated and replaced by the electronics which are integrated in the motor. In this way, the installation expenditure is minimized, the ease of servicing and diagnosis is improved and standstill times of the system are reduced. Fewer lines and plug-type connections and a reduced number of electronic components installed in the sorter element reduce the susceptibility to failure caused by line breakages and caused by contact problems at the points of the previous line connections.

Barrel motors are industrial high-volume products which have undergone comprehensive tests and optimization processes and whose reliability is matched to the rough conditions of industrial use. The barrel motors to be used for the application require no servicing, offer the advantage of a reduction in moving masses and have lower noise emissions than conventional drives, and on account of their extremely compact design, provide above-average efficiency. A reduction in the structural height of the sorter elements results in a considerable material saving and a significantly more compact design. As a result of the integration of the control electronics into the motor, the diagnostic capability in the event of a fault is increased, while a simultaneous reduction in down time is obtained since the drive roller with the control electronics can be exchanged quickly.

### BRIEF DESCRIPTION OF THE DRAWINGS

An exemplary embodiment of the invention is illustrated in the drawing and is described below. In the drawing:

FIG. 1 shows a sorter element according to the invention in a side view,

FIG. 2 shows the sorter element according to FIG. 1 in a plan view, and

FIG. 3 shows the barrel motor according to the invention.

### DETAILED DESCRIPTION OF INVENTION

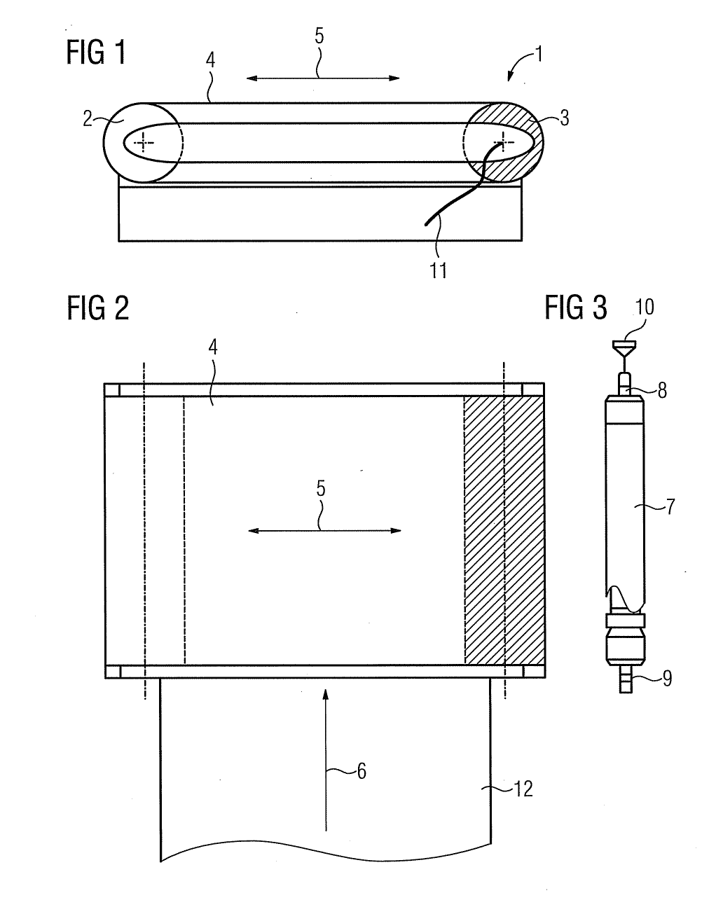

In FIG. 1, a schematically illustrated sorter element is denoted generally by 1, on which sorter element 1 is arranged a cross belt 4 which is guided continuously around two deflection rollers 2 and 3. A piece of goods (not illustrated) rests on the cross belt 4, which piece of goods can be loaded and/or unloaded by driving the cross belt 4 transversely with respect to the transport direction 6 in the arrow direction 5 by means of the deflection roller 3. The deflection roller 3 is hollow and carries, in its interior, the barrel motor 7 which is mounted at both sides, at 8 and 9, on the frame of the sorter element 1. The barrel motor 7 also holds, within the roller body of the deflection roller, the control electronics for the cross belt 4 and also the devices for data communication with the system computer. All the required digital signals or sensor signals can be detected, and used for controlling the system, via a data line which is for example connected to a data bus. The drive energy of the barrel motor 7 is supplied via the power line 11 which is connected to an energy source for the sorter element. The sorter element may be transported on a conveyor belt 12 (not specified in any more detail). To load and unload the sorter element 1, the barrel motor 7 is activated in each case and drives the deflection roller 3 in the direction of the arrow 5. The deflection roller 2 is not driven and is pulled along by means of the cross belt 4 which is wrapped around it.

1.-6. (canceled)

7. A cross belt sorter for transporting and sorting piece goods, comprising:
a plurality of sorter elements which are coupled to form a train or which move individually, each of the plurality of sorter elements comprising:
a plurality of deflection rollers, at least one of the deflection rollers circulated by adrive, and
a cross belt which circulates continuously around the plurality of deflection rollers and is driven transversely with respect to a transport direction of the sorter elements and on which the piece goods are transported in a resting position and loaded and/or unloaded at fixed loading and/or unloading locations,
wherein for at least one of the deflection rollers circulated by the drive, the respective drive is realized by a barrel motor which is arranged within the respective deflection roller.

8. The cross belt sorter as claimed in claim 7, wherein the at least one of the deflection rollers with the barrel motor comprises control electronics which are arranged within the at least one of the deflection rollers along with the barrel motor and which controlling the cross belt of the respective sorter element.

9. The cross belt sorter as claimed in claim 7, wherein the at least one of the deflection rollers with the barrel motor comprises a data communication device which is arranged within the at least one of the deflection rollers along with the barrel motor.

10. The cross belt sorter as claimed in claim 8, wherein the at least one of the deflection rollers with the barrel motor comprises a data communication device which is arranged within the at least one of the deflection rollers along with the barrel motor.

11. The cross belt sorter as claimed in claim 10, wherein a speed and an acceleration of the cross belt corresponding to the at least one of the deflection rollers with the barrel motor is varied externally via the data communication device, the control electronics, and corresponding actuators, integrated in the at least one of the deflection rollers.

12. The cross belt sorter as claimed in claim 8, wherein digital signals or sensor signals are detected directly by the control electronics and are sampled.

13. The cross belt sorter as claimed in claim 12, wherein digital signals or sensor signals are manipulated, externally, via a data bus.

14. The cross belt sorter as claimed in claim 9, wherein digital signals or sensor signals are detected directly by the control electronics and are sampled.

15. The cross belt sorter as claimed in claim 14, wherein digital signals or sensor signals are manipulated, externally, via a data bus.

16. The cross belt sorter as claimed in claim 7, wherein the barrel motor is of low-voltage variants of less than 48V.

17. The cross belt sorter as claimed in claim 8, wherein the barrel motor is of low-voltage variants of less than 48V.

18. The cross belt sorter as claimed in claim 9, wherein the barrel motor is of low-voltage variants of less than 48V.

19. The cross belt sorter as claimed in claim 10, wherein the barrel motor is of low-voltage variants of less than 48V.

20. The cross belt sorter as claimed in claim 11, wherein the barrel motor is of low-voltage variants of less than 48V.

21. The cross belt sorter as claimed in claim 12, wherein the barrel motor is of low-voltage variants of less than 48V.

22. The cross belt sorter as claimed in claim 14, wherein the barrel motor is of low-voltage variants of less than 48V.
